(19) United States
(12) Patent Application Publication
(10) Pub. No.: US 2012/0169105 A1
(43) Pub. Date: Jul. 5, 2012

(54) FITTING FOR A VEHICLE SEAT

(75) Inventors: Uwe Assmann, Remscheid (DE); Bernd Bossmanns, Mettmann (DE)

(73) Assignee: KEIPER GMBH & CO. KG

(21) Appl. No.: 13/395,403

(22) PCT Filed: Aug. 20, 2010
(86) PCT No.: PCT/EP2010/005106

§ 371 Date: Mar. 20, 2012

(30) Foreign Application Priority Data
Sep. 10, 2009 (DE) 10 2009 041 492.4
Dec. 16, 2009 (DE) 20 2009 016 989.8

(51) Int. Cl. B60N 2/235

(52) U.S. Cl. 297/367 P

(57) ABSTRACT

With a fitting for a vehicle seat having a first fitting part and a second fitting part which are rotatable relative to each other about an axis, and which are axially held together by an enclosing ring, a spring arrangement, a rotatably mounted eccentric, upon which a spring arrangement acts, and at least two latches, on which the eccentric acts, and which are guided by the second fitting part in the radial direction with respect to the axis and movable radially outwards, in order to interact with a toothed ring of the first fitting part, in order to lock the fitting, a spring arrangement is configured as one single spiral spring, which, with its first spring end is clamped to and completely supported by a fixture of the one of the two fitting parts and, with its second spring end, at least indirectly acts upon the eccentric.

The invention relates to a fitting for a vehicle seat having the features of the preamble of claim 1.

A fitting of this type is known from DE 10 2005 046 807 B3. The spring arrangement consists of two spiral springs which include each other, in order to act upon the eccentric without lateral force.

The object of the invention is to create an alternative fitting to the type mentioned in the introduction. This object is achieved according to the invention by a fitting having the features of claim 1. Advantageous configurations are the subject-matter of the subordinate claims.

The spring arrangement is configured as one single spiral spring. With its first spring end which is preferably arranged radially outside, the spring arrangement is clamped to a fixture of one of the two fitting parts and completely supported, i.e. the first spring end is completely immobile relative to the fixture. The second spring end, which is preferably arranged radially inside, therefore does no longer need to support the spring arrangement and can thus provide a pure torque with which it acts at least indirectly upon the eccentric. It is thus possible to act upon the eccentric without lateral force or almost free of lateral force.

For clamping the first spring end, said spring end bears against the fixture—in a plane of the spiral-shaped part—preferably in at least two points. Particularly preferably, the first spring end bears against the fixture in a form-fitting manner. The fixture can be a suitable receptacle for the first spring end, or the first spring end forms a suitable receptacle for the fixture.

The second spring end preferably is adjacent in a form-fitting manner, too, more precisely it is against to the eccentric or to a driver which is coupled with the eccentric in a rotationally rigid manner or at least mechanically connected to it. With the first possibility, a decoupling between driver and eccentric, preferably by means of an idle travel, is possible. The second possibility excludes such a decoupling, but it permits a greater spring length (since the second spring end can be located several windings further inside), so that a flatter spring load-deflection curve is possible.

Preferably, the two innermost located windings in some sections bear against each other, for example by a contact section in the winding bearing against the second spring end after the second spring end. The spring arrangement then presses—due its biasing—against the driver in a self-locking manner, i.e. it secures the form fit between the second spring end and the driver. This configuration of the spring arrangement in the area of the second spring end is independent of the configuration of the spring arrangement in the area of the first spring end, so that it can be put to practice in different combinations.

The fitting is preferably used for adjusting the inclination of the backrest of the vehicle seat, but it can also be used at other locations of the vehicle seat, for example as an adjusting mechanism for the height or for the seat inclination. The spring arrangement can act upon both, a movable component of a locking device of the fitting, in the present case the driver or the eccentric, and it can also act between the two fitting parts, for example as a compensation spring between backrest and seat part, or between a rocker arm and the seat frame. The notion “fitting” shall then be understood comprehensively and comprise also non-lockable joints.

The invention is explained in more detail hereinafter with reference to an exemplary embodiment in different variant types shown in the drawing, in which

FIG. 1 shows a first variant type with a pin as a fixture for the spring arrangement and with an impingement of the driver,

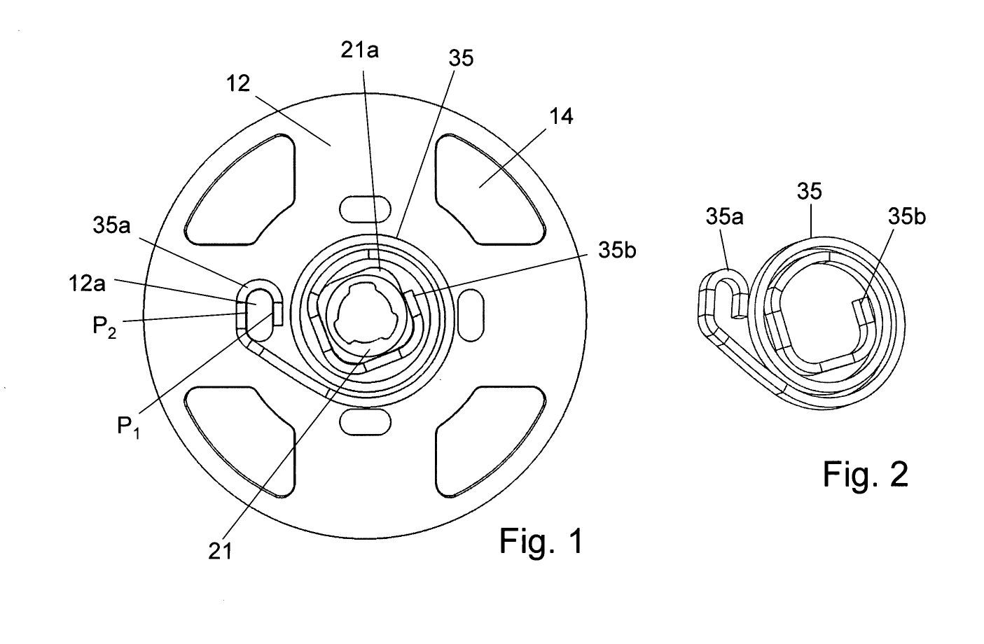

FIG. 2 shows a perspective view of the spring arrangement of FIG. 1,

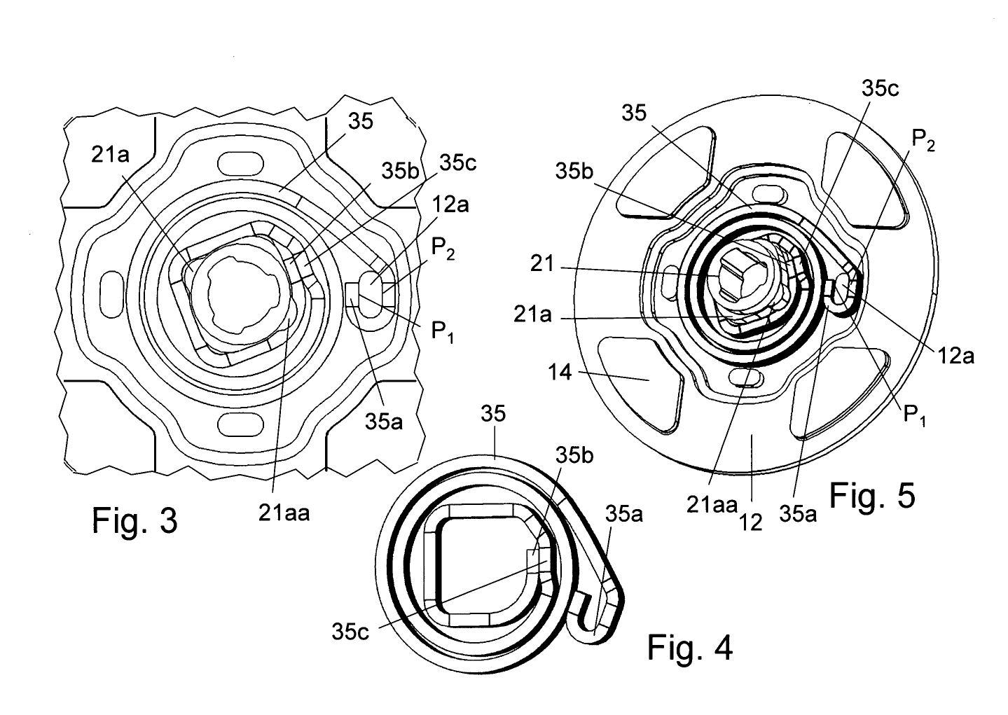

FIG. 3 shows a second variant type with a pin as a fixture for the spring arrangement and an impingement of the driver,

FIG. 4 shows a perspective view of the spring arrangement of FIG. 3,

FIG. 5 shows a perspective view of the second variant type of FIG. 3,

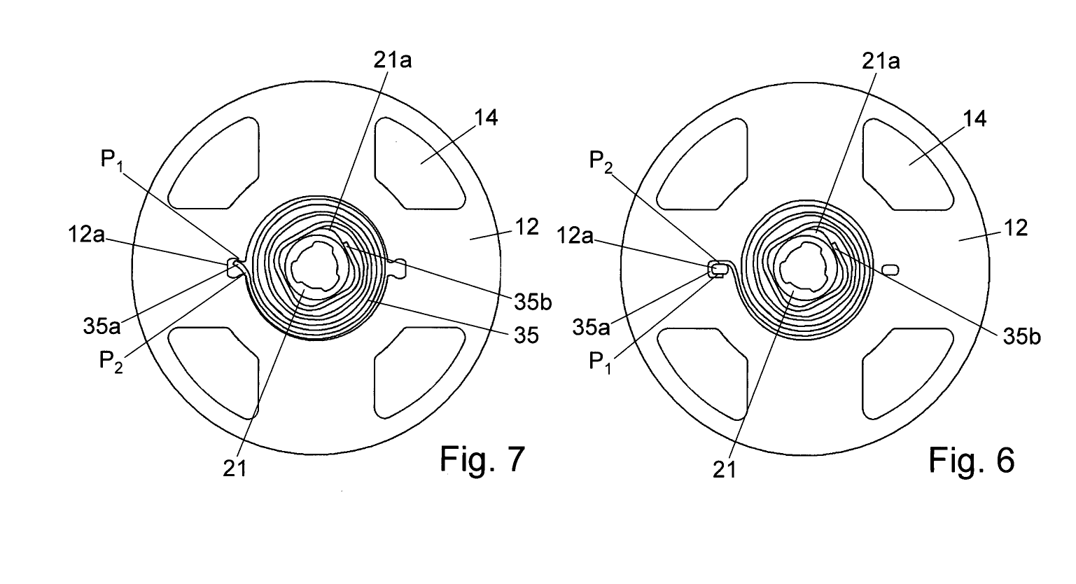

FIG. 6 shows a third variant type with a pin as a fixture for the spring arrangement and an impingement of the driver,

FIG. 7 shows a fourth variant type with a receptacle as a fixture for the spring arrangement and an impingement of the driver,

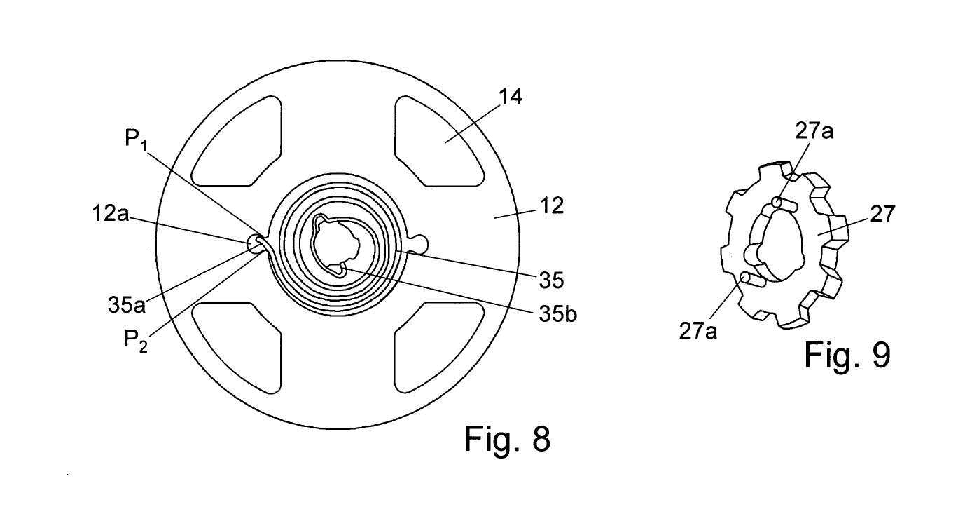

FIG. 8 shows a fifth variant type with a receptacle as a fixture for the spring arrangement and a direct impingement of the driver,

FIG. 9 shows a perspective view of the eccentric pertaining to the fifth variant type,

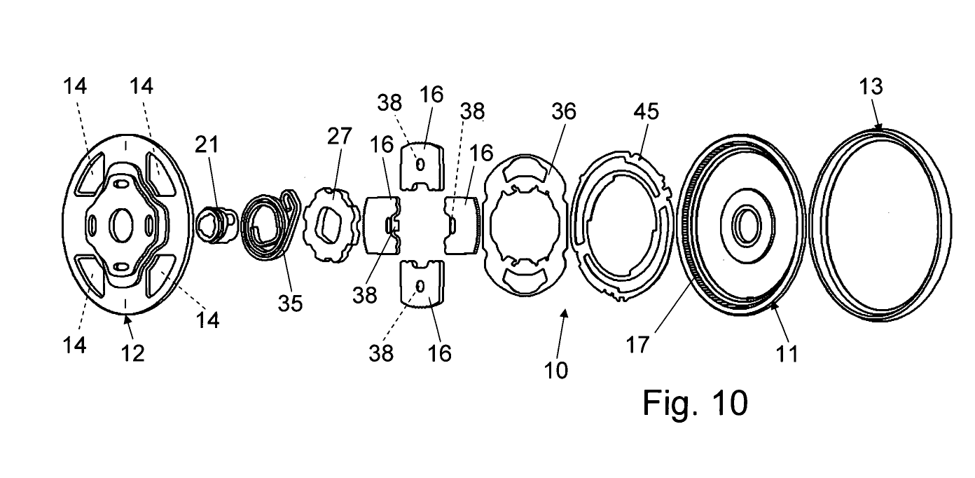

FIG. 10 shows an exploded view of a fitting with a pin as a fixture for the spring arrangement,

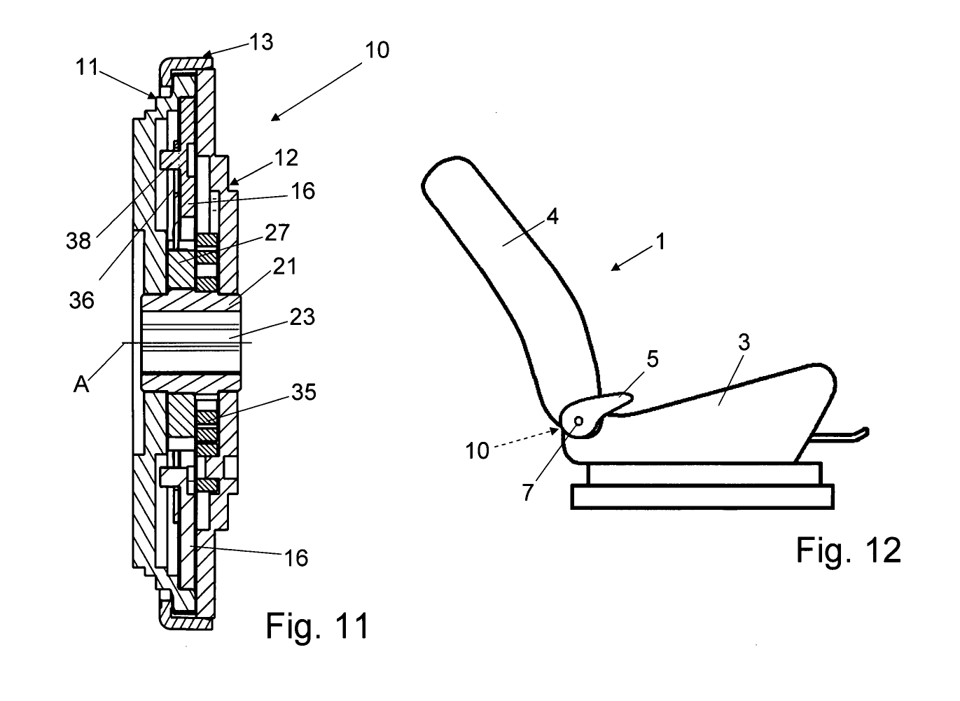

FIG. 11 shows an axial cut through the fitting of FIG. 10,

FIG. 12 shows a schematic view of a vehicle seat,

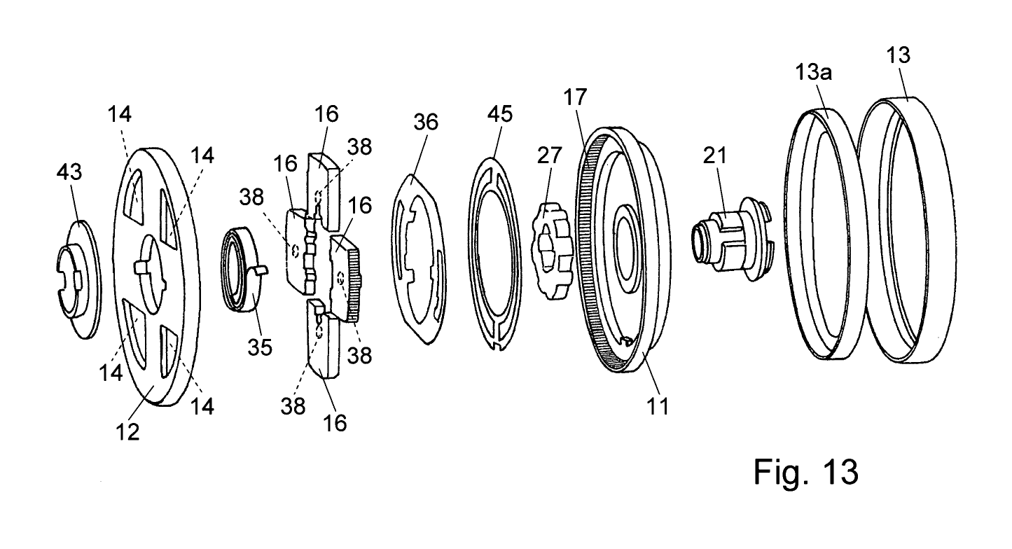

FIG. 13 shows an exploded view of a fitting with a receptacle as a fixture for the spring arrangement, and

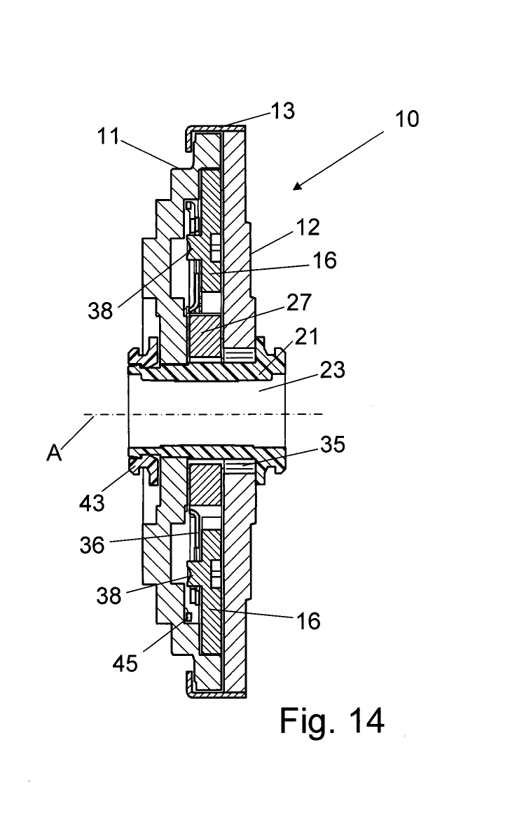

FIG. 14 shows an axial cut through the fitting of FIG. 13.

A vehicle seat 1 for a motor vehicle has a seat part 3 and a backrest 4, the inclination of which is adjustable relative to the seat part 3. In order to adjust the inclination of the backrest 4, a transmission rod 7, which is arranged horizontally in the transition region between the seat part 3 and the backrest 4, is rotated manually, for example, by means of a hand lever 5. On both sides of the vehicle seat 1, the trans-mission rod 7 engages in a fitting 10. The transmission rod 7 defines the adopted directional data of a cylinder coordinate system.

The fitting 10 is configured as a detent fitting, in which a first fitting part 11 and a second fitting part 12 can be locked with each other and, after unlocking, can be rotated relative to each other about an axis A (which aligns with the transmission rod 7), as is described, for example, in DE 10 2006 015 560 B3, the relevant disclosure of which is expressly incorporated herein.

With the mounting of the fitting 10, the first fitting part 11 is, for example, connected tightly to the structure of the backrest 4, i.e. it is fixed with respect to the backrest part. The second fitting part 12 is then connected tightly to the structure of the seat part 3, i.e. it is fixed with respect to the seat part. Those assignments of the fitting parts 11 and 12 can, however, also be exchanged, i.e. the first fitting part 11 would then be fixed with respect to the seat part and the second fitting part 12 would be fixed with respect to the backrest.

Each of the two fitting parts 11 and 12 can be approximately inscribed in a circular disc shape. The two fitting parts 11 and 12 are preferably composed of metal, particularly of tempered steel. In order to absorb the axially acting forces, i.e. in order to hold the fitting parts 11 and 12 axially together, an enclosing ring 13 is provided. Such holding together by means of an enclosing ring is described, for example, in U.S. Pat. No. 6,799,806 B2. The preferably metallic, untempered enclosing ring 13 is tightly connected with one of the two fitting parts 11 and 12, for example with the second fitting part 12, preferably it is welded or—by engaging over the fitting part to which it is connected—bent over. At one of its front faces, the enclosing ring 13 has an edge which is radially bent inwards, by means of which it engages over the other one of the two fitting parts 11 and 12, for example over the first fitting part 11 radially outside, if appropriate by the interposition of a sliding ring 13a, without impeding the relative movement of the two fitting parts 11 and 12. From a structural point of view, the two fitting parts 11 and 12 together (with the enclosing ring 13) consequently form a disc-shaped unit.

The second fitting part 12 has—in the present case four—guide segments 14 which, with their straight guide faces, respectively guide a latch 16 pairwise laterally in the radial direction. The—in the present case four—latches 16 are displaced with respect to each other—in the present case by 90° each—and arranged in an installation space which is defined between the two fitting parts 11 and 12. The latches 16 are provided at their radially outer end with a toothing which engages (fits) with a toothed ring 17 of the first fitting part 11 which is configured as a hollow wheel. If the toothed ring 17 and the latches 16 interact with each other, the fitting 10 is locked. The guide segments 14 bear with one bent bearing surface each against the toothed ring 17 of the first fitting part 11, the two fitting parts 11 and 12 thus supporting each other.

A driver 21, for example composed of plastic material, is arranged in the center of the fitting 10, said driver being located in a rotationally rigid manner—or at least mechanically connected—on the transmission rod 7 by means of a central bore 23 and being supported rotatably on at least one of the two fitting parts 11 and 12, in the present case on the first fitting part 11, and more precisely in a central recess thereof.

An eccentric is located on the driver 21 in a rotationally rigid manner or at least mechanically connected to it, said eccentric being arranged in an installation space which is defined between the fitting parts 11 and 12. A spring arrangement 35 is arranged at least partially in an installation space which is provided by one of the two fitting parts 11 and 12, in the present case by the second fitting part 12, and, in the present case, supported (radially) outside. The spring arrangement 35 acts upon the eccentric 27 directly or indirectly, for example by being located (radially) inside the driver 21 in a rotationally rigid manner. The eccentric 27 which is under the action of the spring arrangement 35 acts upon the radially movable latches 16 and impinges on them, so that they are pressed radially outwards, in order to engage in the toothed ring 17, thus locking the fitting 10.

A control disc 36 is arranged in the installation space axially between the latches 16 and the first fitting part 11 and is arranged—in the present case in a rotationally rigid manner—on the eccentric 27. The control disc 36 has—in the present case four—control curves which interact with respectively one lug 38 of each latch 16. The lugs 38 axially protrude from the assigned latches 16.

The driver is secured axially, for example by a retaining ring 43, which, during mounting of the fitting 10 is fixed, preferably clipped on, to the driver 21. The driver 21 and the retaining ring 43 each have one flange which respectively bears against the outside of one of the two fitting parts 11 or 12 and which acts as a sealing. In the axial direction, the driver 21 can have in its center a bigger diameter than at its ends which are supported in the fitting parts 11 and 12, so that the two fitting parts 11 and 12 axially secure the driver 21, and the securing ring 43 is omitted.

In the event of a rotation (by few degrees) of the driver 21—and of the eccentric 27 which is driven by it, and of the control disc 36—counter to the force of the spring arrangement 35, the control disc 36 pulls the latches 16 radially inward, i.e. out of the toothed ring 17, the fitting 10 thus being unlocked, and the two fitting parts 11 and 12 being rotatable relative to each other about the axis A. The inclination of the backrest 4 is thus adjustable between several positions of use, suitable for seating use.

With two-door motor vehicles, access to a rear seat row shall be facilitated by a free-pivoting of the backrest 4, for which purpose the unlocked backrest 4 is pivoted forward from one of the use positions into a free-pivoted position which is not suitable for seating use. User comfort is increased, if the hand lever 5—or a further actuating element—does not need to be held during the whole free-pivoting process, and the fittings nevertheless lock in the free-pivoted position. An annular free-pivoting control element 45 is provided for this purpose in the fitting 10, between the control disc 36 and the first fitting part 11, around the axis A, such control element being connected in a rotationally rigid manner with the first fitting part 11. The free-pivoting control element 48 is provided with stop guides which interact with the lugs 38 of the latches 16 by limiting the movement thereof radially outwards or by letting it engage unimpededly. In order to enable a free-pivoting of the backrest 4 over more than the angle between two latches 16, the lugs 38 of the latches 16 are arranged alternately, to a different extent radially outside or radially inside on the assigned latches 16, so that adjacent lugs 38 interact with different stop guides. Correspondingly, two different configurations of the latches 16 are provided. Details are described in DE 10 2006 015 560 B3.

According to the invention, the spring arrangement 35 is configured as one single spiral spring. The windings of the spiral-shaped part of the spring arrangement 35, which is arranged in one plane, preferably have identical spacings to one another. The spring arrangement 35 is, on its radially outer first spring end 35a, tightly clamped in the second fitting part 12. For this purpose, a fixture 12a is configured on the second fitting part 12—radially outside the space needed for the spiral-shaped part of the spring arrangement 35—, the first spring end 35a of the spring arrangement 35 being adjacent to said fixture 12a, in the plane of the spiral-shaped part, in at least two opposite points P₁ and P₂, the spring arrangement 35 thus being supported.

In a first variant type (FIGS. 1 and 2), a second variant type (FIGS. 3, 4 and 5) and a third variant type (FIG. 6), the fixture 12a is an oblong pin which axially protrudes from the second fitting part 12, said pin being enclosed in a form-fitting manner by the radially outer first spring end 35a of the spring arrangement 35. The fixture 12a is thereby oriented tangentially in the first and in the second variant type and radially in the third variant type. Furthermore, the first spring end 35a in the third variant type has a curvature which is opposed to and, in the first and in the second variant type, a curvature which is identical to the curvature of the spiral-shaped part of the spring arrangement 35. The points P₁ and P₂ are located at the two opposite long sides of the pin which serves as fixture 12a.

In a fourth variant type (FIG. 7) and a fifth variant type (FIGS. 8 and 9), the fixture 12a is a U-shaped receptacle in the material of the second fitting part, said receptacle opening radially inwards and being introduced in the first spring end 35a. The points P₁ and P₂ are located at the two opposite inner sides of this receptacle.

Since the spring arrangement 35, by being clamped in the fixture 12a, is already completely supported on such fixture, it can act on the eccentric 27 without lateral force with its radially inner second spring end 35b. The spring torque increases in a linear way over the actuation angle.

In the first variant type (FIGS. 1 and 2), the second variant type (FIGS. 3, 4 and 5), the third variant type (FIG. 6) and the fourth variant type (FIG. 7), the spring arrangement 35 acts indirectly on the eccentric 27. The spring arrangement 35 is, with its second spring end 35, adjacent in a form-fitting manner to a square 21a which is configured on the driver 21. The form closure of the second spring end 35b with the square 21a takes place on all four sides of the square 21a, at least in some sections each, at some sides also completely. The driver 21 then acts upon the eccentric 27.

The second variant type is improved to the effect that is has a self-securing inner receptacle. The spring arrangement 35 has, in the winding after the second spring end 35b (i.e. one winding more radially outwards than the second spring end 35b), a contact section 35c. This contact section 35c represents a deviation from the regular contour of the spiral-shaped part of the spring arrangement 35, said deviation protruding inwards. The contact section 35c bears against the second spring end 35b, i.e. the radially inner side of the contact section 35c is in contact with the radially outer side of the second spring end 35b, and more precisely with a bias, in the present case the bias of the spring arrangement 35. Such bearing of the contact section 35c against the second spring end 35b, namely the two innermost windings, prevents the second spring end 35b from dilating and from slipping off the driver 21, i.e. from its square 21a. The higher the spring torque, the higher is the contact force between the contact section 35c, the second spring end 35b and the driver 21.

The edge of the square 21a of the driver 21 which follows the second spring end 35b is defined by a cam 21aa which serves for driving the eccentric 27. The cam 21aa is preferably configured with an undercut (in the axially direction). The section of the spring arrangement 35 which follows the second spring end 35b preferably has a bigger radius of curvature than the cam 21aa, so that this section of the spring arrangement 35 comes to lie in the undercut of the cam 21aa, i.e. engages behind the cam 21aa (in the axial direction). This enlarges, on the one hand, the installation space for the next winding (i.e. the winding with the contact section 35c) and, on the other hand, creates an axial safeguard for the spring arrangement 35.

In the fifth variant type (FIGS. 8 and 9) the spring arrangement 35 directly acts upon the eccentric 27. The spring arrangement 35 bears in a form-fitting manner, with its second spring end 35b, against two pins 27a which are opposed to each other with respect to the axis A and axially protrude from the eccentric 27. Such configuration makes it possible that the driver 21 and the eccentric 27 are decoupled by means of an idle travel.

### LIST OF REFERENCE NUMERALS

1 vehicle seat
3 seat part
4 backrest
5 hand lever
7 transmission rod
10 fitting
11 first fitting part
12 second fitting part
12a fixture
13 enclosing ring
13a sliding ring
14 guide segment
16 latch
17 toothed ring
21 driver
21a square
21aa cam
23 bore
27 eccentric
27a pin
35 spring arrangement
35a first spring end
35b second spring end
35c contact section
36 control disc
48 lug
43 retaining ring
45 free-pivoting control element
A axis
P₁, P₂ point

1. A fitting for a vehicle seat, comprising:
a first fitting part and a second fitting part which are rotatable relative to each other about an axis, and which are axially held together by an enclosing ring,
a spring arrangement,
a rotatably mounted eccentric, upon which the spring arrangement acts,
a rotatably mounted driver which is at least one of coupled with the eccentric in a rotationally rigid manner and mechanically connected to the eccentric, and
at least two latches, on which the eccentric acts, and which are guided by the second fitting part in the radial direction with respect to the axis and movable radially outwards, in order to interact with a toothed ring of the first fitting part, in order to lock the fitting,
wherein
the spring arrangement is configured as one single spiral spring,
which, with its first spring end is clamped to and completely supported by a fixture of the one of the two fitting parts and,
with its second spring end at least indirectly acts upon the eccentric, whereby the second spring end bears against the driver.

2. A fitting according to claim 1, wherein the fixture is configured as an oblong pin on the second fitting part, against which the first spring end bears in a form-fitting manner.

3. A fitting according to claim 1, wherein the first spring end bears against the fixture in at least two opposite points in the plane of the spiral-shaped part of the spring arrangement.

4. (canceled)

5. A fitting according to claim 1, wherein a rotatable control disc interacts with lugs of the latches, wherein the control disc pulls the latches inwards when rotating, in order to unlock the fitting.

6. A fitting according to claim 5, wherein the driver is at least one of coupled with the control disc in a rotationally rigid manner and mechanically connected to the control disc and turns the control disc when rotating, in order to move the latches radially inwards.

7. A fitting according to claim 6, wherein the spring arrangement, with its second spring end, directly acts on the eccentric, particularly by the second spring end bearing in a form-fitting manner against two axially protruding pins of the eccentric, such pins being opposed to each other with respect to the axis.

8. (canceled)

9. A fitting according to claim 1, wherein the second spring end bears against the driver, particularly against a square of the driver.

10. A fitting according to claim 1, wherein the driver has a cam which engages behind the spring arrangement, particularly in the section which follows the second spring end.

11. A fitting according to claim 10, wherein the cam defines an edge of the square, particularly the edge which follows the second spring end.

12. A fitting according to claim 1, wherein the spring arrangement has, in the winding after the second spring end, a contact section which bears against the second spring end particularly with bias.

13. A fitting according to claim 12, wherein the contact section which is protruding radially inwards bears with its radially inner side against the radially outer side of the second spring end.

14. A fitting according to claim 1, wherein guide segments are configured on the second fitting part, for bearing the first fitting part, particularly on the toothed ring, and/or for guiding the latches, wherein the latches interact with the toothed ring, in order to lock the fitting.

15. A vehicle seat, in particular a motor vehicle seat, having a fitting according to claim 1.

16. A fitting according to claim 1, wherein the fixture is configured as a U-shaped receptacle in the fitting part, in which the first spring end is introduced.
